(19) United States
(12) Patent Application Publication
(10) Pub. No.: US 2026/0024950 A1
(43) Pub. Date: Jan. 22, 2026

(54) SOCKET CONNECTOR

(71) Applicant: YFC-BONEAGLE ELECTRIC CO., LTD., Taoyuan City (TW)

(72) Inventors: Sheng-Cheng SHEN, Taoyuan City (TW); Huiyu JI, Wuxi (CN); Bin YE, Wuxi (CN); Qing CHEN, Wuxi (CN)

(21) Appl. No.: 18/797,515

(22) Filed: Aug. 8, 2024

(30) Foreign Application Priority Data
Jul. 18, 2024 (TW) 113207725

(51) Int. Cl. H01R 24/20; H01R 13/627; H01R 13/635

(52) U.S. Cl. CPC H01R 24/20; H01R 13/6276; H01R 13/635

(57) ABSTRACT

A socket connector includes an insulative body (100), a conductor (200), a ball (300) and a slider (400). The insulative body (100) has a socket (101), a slide channel (102) and a communicating path (103), and the communicating path (103) is connected to one side on the socket (101) and one sided on the slide channel (102). The conductor (200) is arranged in the socket (101), and the communicating path (103) is disposed corresponding to one side of the conductor (200). The ball (300) is disposed in the communicating path (103). The slider (400) is disposed in the slide channel (102), and the slider (400) has a slope (401). The slider (400) is slidable along the slide channel (102) to a locking position to press the ball (300) by the slope (401) so as to push the ball (300) into the socket (101) to abut against the conductor (200).

### BACKGROUND OF THE DISCLOSURE

### Technical Field

This disclosure is directed to a socket connector, in particular to a socket connector having a locking mechanism.

### Description of Related Art

In general, a power extension cable of related art has a plug at one end thereof and at least a female socket connector at the other end thereof. This female socket connector is moved with the extension cable, and a plug coupled with this female socket may fall off due to accidental contact.

In views of this, in order to solve the above disadvantage, the inventor studied related technology and provided a reasonable and effective solution in this disclosure.

### SUMMARY OF THE INVENTION

This disclosure is directed to a socket connector having a locking mechanism.

This disclosure is directed to a socket connector at least having an insulative body, a conductor, a ball and a slider. The insulative body has a socket, a slide channel and a communicating path, and the communicating path is connected to one side on the socket and one sided on the slide channel. The conductor is arranged in the socket, and the communicating path is disposed corresponding to one side of the conductor. The ball is disposed in the communicating path. The slider is disposed in the slide channel, and the slider has a slope. The slider is slidable along the slide channel to a locking position to press the ball by the slope so as to push the ball into the socket to abut against the conductor.

In one embodiment, the slider has a push button, and the push button protrudes from the insulative body for pushing the slider to move.

In one embodiment, the insulative body has a socket port at one end thereof, the socket port is communicated to one end of the socket.

In one embodiment, the slider has a latch, and the latch is snap fastened on an internal surfaced of the slide channel when the ball is in the socket.

In one embodiment, the insulative body has a window on a lateral surface thereof, the window is communicated with the slide channel, and the latch is disposed in the window when the slider is away from the locking position and the ball is retreated from the socket.

In one embodiment, the slider has an elastic arm and a push button, the latch and the push button are disposed together on the elastic arm and linked with the elastic arm.

In one embodiment, the push button protrudes from the insulative body through the window for pressing the elastic arm.

In one embodiment, an elastic part is arranged in the slide channel, the elastic part is disposed along a longitudinal direction of the slide channel, and the elastic part respectively abuts on an internal surface of the slide channel and the slider so as to push the slider away from the locking position.

In one embodiment, the conductor comprises a pair of claws, the pair of claws are disposed opposite to each other, one of the pair of claws is disposed corresponding to the communicating path.

The socket connector according to this disclosure is used for coupling with a plug as a counterpart, plug terminals on the plug are respectively plugged into the sockets through the socket ports so as to be respectively coupled with the conductors. When the plug terminal is inserted between two claws of the conductor, the slider may be then pushed along a longitudinal direction of the insulative body to the locking position by operating the push button corresponding to the slider so as to correspondingly push the ball into the socket to fasten the plug terminal. The push button of the slider may be pressed along a lateral direction of the insulative body to retreat the plug, so as to move the latch to release the slider. When the slider is away from the locking position, the ball is retreated from the socket to release the plug terminal.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing a socket connector according to one embodiment of this disclosure.

FIGS. 2 and 3 are exploded views showing the socket connector according to the embodiment of this disclosure.

FIGS. 4 and 5 are cross-sectional views of the socket connector according to the embodiment of this disclosure.

FIGS. 6 and 7 are perspective views showing operation status of the socket connector according to the embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the flowing paragraph with reference to the drawings. However, the drawings are attached only for illustration and are not intended to limit this disclosure.

It should be understood that the orientations or positional relationships in this disclosure which are indicated by the terms such as “front side”, “rear side”, “left side”, “right side”, “front end”, “rear end”, “end”, “vertical”, “horizontal”, “vertical”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to +10% of the numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

The detail descriptions and technical contents of this disclosure are described in the following paragraphs with reference to the drawings. However, the attached drawings are only used for illustrative purposes rather than limitations of the scopes of this disclosure.

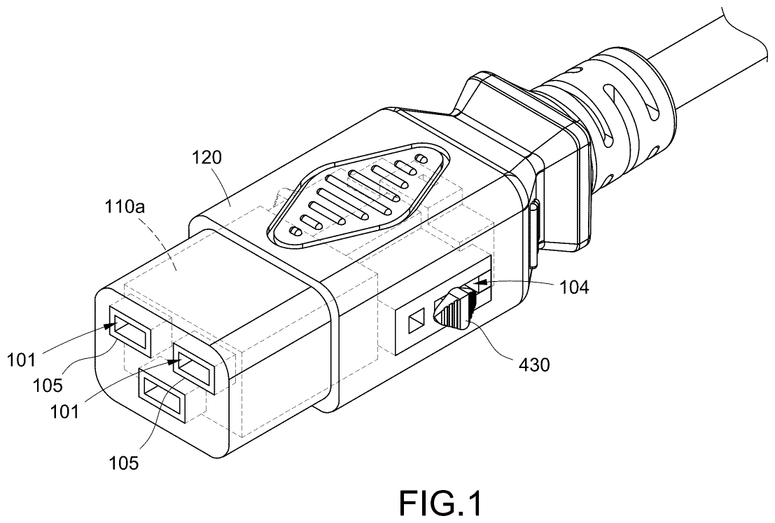

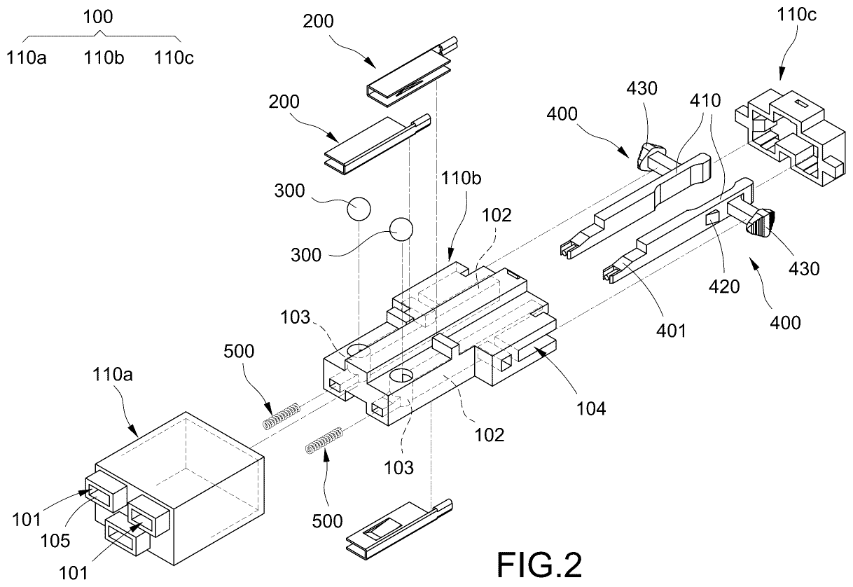

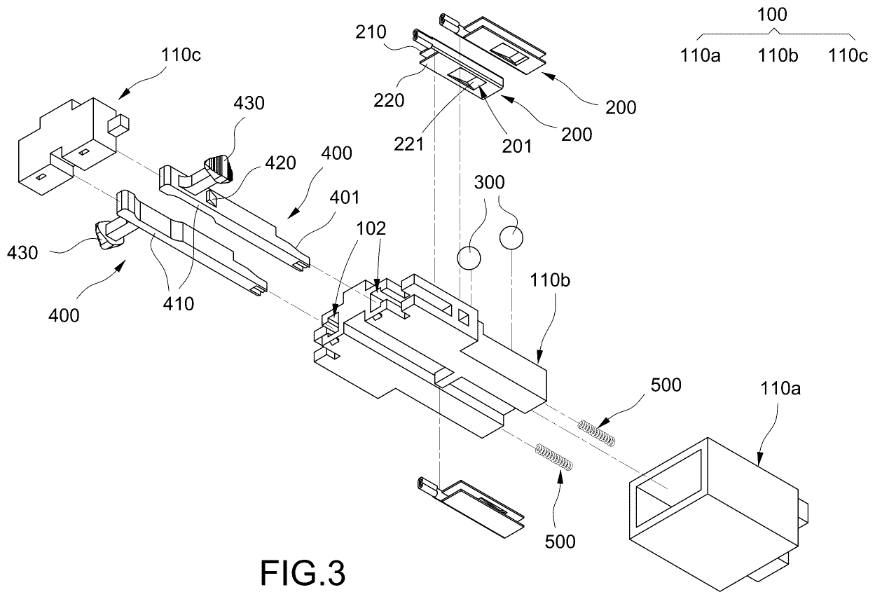

According to FIGS. 1 to 5, one embodiment of this disclosure provides a socket connector used for connection of electric power transmission. With regard to a simplest embodiment, the socket connector of this disclosure at least has an insulative body 100, a conductor 200, a ball 300 and a slider 400. According to this embodiment, the socket connector at least has one insulative body 100, three conductors 200, two balls 300 corresponding to two of the conductors 200 and two sliders 400, but this disclosure should not be limited to this. Three of the conductors 200 are respectively disposed as an anode, a cathode and a ground, two of the balls 300 and two of the sliders 400 are disposed as locking mechanisms respectively corresponding to the conductors 200 as the anode and the cathode. Two of the locking mechanisms have arrangements and operations the same as each other. In order to illustrate the configuration of the locking mechanism, an example described in the following paragraphs is directed to only one of the conductors 200 as the anode and the cathode and described with corresponding components, and the same configuration of the other will be omitted.

The insulative body 100 at least has a socket 101, and corresponding to the socket 101 further has a slide channel 102 and a communicating path 103. The communicating path 103 is communicated to one side of the socket 101 and one side of the slide channel 102. According to this embodiment, the insulative body 100 has three sockets 101 corresponding to three of the conductors 200, and further has a socket 101, a slide channel 102 and a communicating path 103 corresponding to the each of the conductors 200 as the anode and the cathode. In other words, the insulative body 100 has two sockets 101, two slide channels 102 and two communicating paths 103.

According to this embodiment, the insulative body 100 is columnar, but scopes of this disclosure should not be limited to this. The insulative body 100 has at least one structural part (110a, 110b, 110c) and an elastic covering 120. According to this embodiment, the insulative body 100 has three structural parts (110a, 110b, 110c), but the number of the structural parts (110a, 110b, 110c) should not be limited to the number mentioned above. Various numbers of the structural parts (110a, 110b, 110c) may be provided according to various requirements of manufacturing and assembling. The socket 101, the slide channel 102 and the communicating path 103 are respectively defined by the structural parts (110a, 110b, 110c) with structural strength sufficient to withstand forces caused by operations. The structural parts (110a, 110b, 110c) are embedded in the elastic covering 120, so that the elastic covering 120 may defend unexpected external forces. Moreover, the sockets 101 and the slide channels 102 are respectively extended parallel to a longitudinal direction of the insulative body 100.

According to this embodiment, corresponding to each of the sockets 101, a socket port 105 is arranged on one end of the insulative body 100. Corresponding to each of the slide channels 102, the insulative body 100 is provided with at least one window 104 on a side surface thereof. The socket port 105 is correspondingly communicated to one end of the socket 101, and the window 104 is correspondingly communicated to the slide channel 102. Three of the socket ports 105 mentioned above are disposed together on an end surface of the insulative body 100.

The conductors 200 are disposed in the sockets 101 respectively. The conductors 200 as the anode and the cathode have structures the same as each other, and an example mentioned in the following paragraph is directed to only one of these. Specifically, the conductor 200 has a pair of claws (210,220), and the pair of claws (210,220) are disposed opposite to each other.

The balls 300 may be conductive or insulative, and the balls 300 are respectively disposed on the communicating paths 103.

The sliders 400 are disposed in the slide channels 102 respectively, two of the sliders 400 have structures and operations the same as each other, and an example mentioned in the following paragraph is directed to only one of these. The slider 400 has a slope 401, and the slider 400 further has an elastic arm 410, a latch 420 and a push button 430.

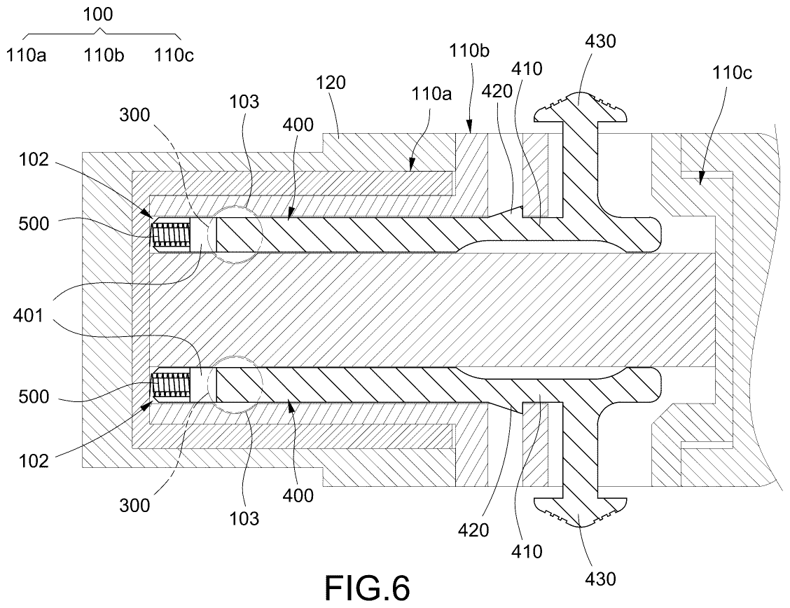

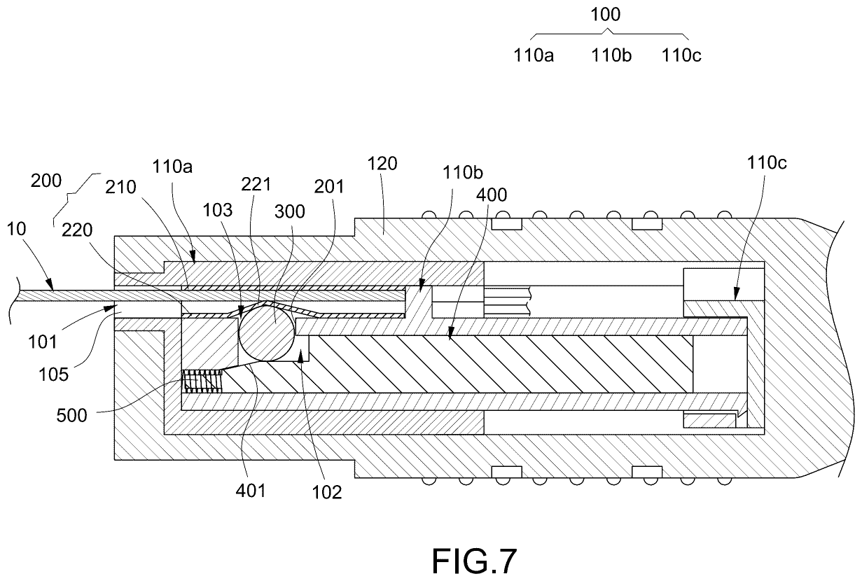

The slider 400 is slidable along the slide channel 102 to a locking position as shown in FIGS. 6 and 7 where the ball 300 is pressed by the slope 401 so as to push the ball 300 into the socket 101. The latch 420 and the push button 430 are disposed together on the elastic arm 410, the push button 430 protrudes from the insulative body 100 for pushing the slider 400 to move. Specifically, the push button 430 protrudes from the insulative body 100 through the window 104.

The ball 300 is in the socket 101 when the slider 400 is located at the locking position, and the latch 420 is snap fastened on an internal surface of the slide channel 102 (via any structures protruding from or denting into the internal surface for snap fastening) so as to position the slider 400 at the locking position and position the ball 300 in the socket 101. The latch 420 and the push button 430 are disposed together on the elastic arm 410 to be linked with the elastic arm 410, the push button 430 protrudes from the insulative body 100 through the window 104 for pressing the elastic arm 410. The elastic arm 410 may be pressed by the push button 430 when the slider 400 is positioned at the locking position to cause an elastic deformation on the elastic arm 410 so that the latch 420 may be retreated from the internal surface of the slide channel 102 to release the slider 400.

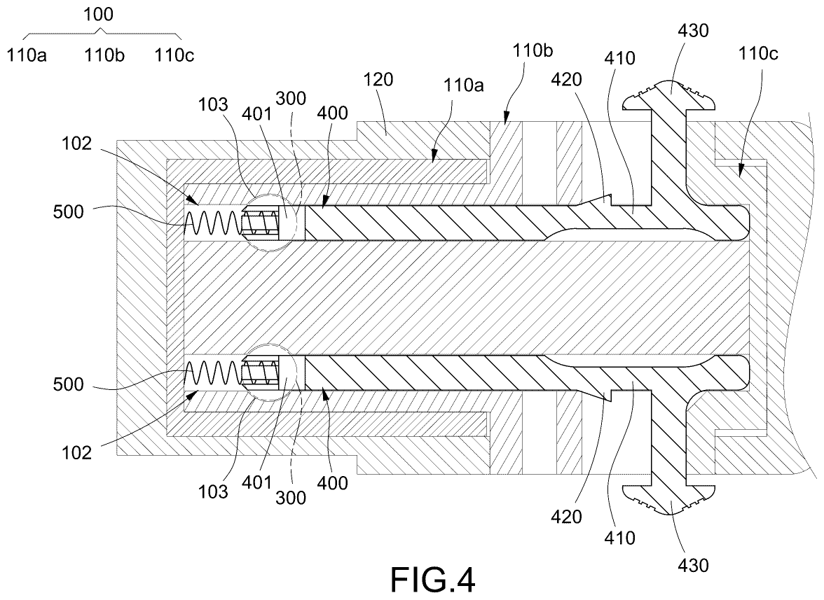

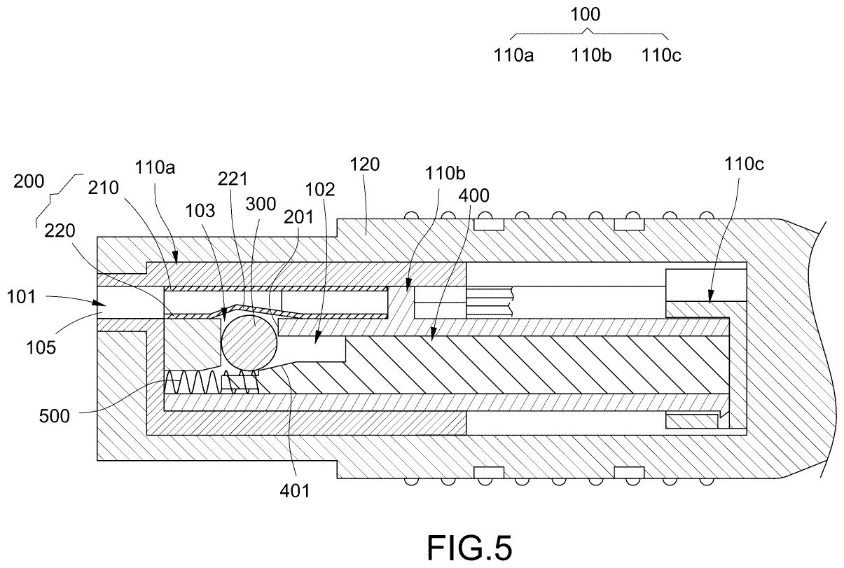

The locking mechanism mentioned above may further have an elastic part 500, the elastic part 500 is arranged in the slide channel 102, the elastic part 500 is disposed along a longitudinal direction of the slide channel 102, and the elastic part 500 abuts an internal surface of the slide channel 102 and the slider 400 so as to push the slider 400 away from the locking position. According to FIGS. 4 and 5, the latch 420 is positioned in the window 104 when the slider 400 is away from the locking position and the ball 300 is retreated from the socket 101.

According to FIGS. 6 and 7, the socket connector of this disclosure is used for coupling with a counterpart which is a plug. In general, the plug as the counterpart at least has a pair of plug terminals 10 corresponding to the conductors 200 used as the anode and the cathode. Accordingly, the socket connector of this disclosure has the locking mechanisms disposed corresponding to the conductors 200 used as the anode and the cathode. When the socket connector of this disclosure is coupled with the plug. The plug terminals 10 of the plug as the counterpart is respectively plugged into the socket 101 through the socket ports 105 to respectively plug the conductors 200. Similarly, an example mentioned in the following paragraph is exemplified with only one of conductors 200 used as the anode and the cathode and its corresponding plug terminal 10. The plug terminal 10 is inserted between two of the claws 210,220 of the conductor 200, the slider 400 may be pushed along the longitudinal direction of the insulative body 100 to the locking position by operating the push button 430 of the slider 400 corresponding to the conductor 200. Accordingly, the ball 300 is moved into the socket 101 to abut against the conductor 200 and tightly fix the plug terminal 10, the conductor 200 may be deformed by pressing. Specifically, the conductor 200 is pressed by the ball 300 at the claw (210, 220) correspondingly.

According to this embodiment, the conductor 200 may have an elastic piece 221 formed by punching for abutting against the plug terminal 10, the elastic piece 221 is disposed on one of the claws 220 corresponding to the communicating path 103, an opening 201 is formed meanwhile at apportion which is punched, the opening 201 is disposed corresponding to the communicating path 103 to allow the ball 300 passing there through for abutting against the elastic piece 221.

The push button 430 of the slider 400 is pressed along a lateral direction of the insulative body 100 when the plug is retreated, so as to move the latch 420 to release the slider 400. When the slider 400 is moved away from the locking position, the ball 300 is retreated from the socket 101 to release the plug terminal 10.

When the slider 400 is moved by an operation to the push button 430 along the longitudinal direction of the insulative body 100 to the locking position, a direction of the operation is toward the socket port 105, namely toward the plug, so that the direction of the operation is the same as a direction of coupling and it is therefore easy for operating. When the plug is retreated, the push button 430 is pressed along a lateral direction of the insulative body 100 and the insulative body 100 is meanwhile tightly held for detaching.

Although this disclosure has been described with reference to the foregoing embodiment, it will be understood that the disclosure is not limited to the details thereof. Various equivalent variations and modifications can still occur to those skilled in this art in view of the teachings of this disclosure. Thus, all such variations and equivalent modifications are also embraced within the scope of this disclosure as defined in the appended claims.

What is claimed is:

1. A socket connector, comprising:
an insulative body (100) comprising a socket (101), a slide channel (102) and a communicating path (103), the communicating path (103) connected to one side on the socket (101) and one sided on the slide channel (102);
a conductor (200), arranged in the socket (101), and the communicating path (103) disposed corresponding to one side of the conductor (200);
a ball (300), disposed in the communicating path (103); and
a slider (400), disposed in the slide channel (102), the slider (400) comprising a slope (401);
wherein the slider (400) is slidable along the slide channel (102) to a locking position to press the ball (300) by the slope (401) so as to push the ball (300) into the socket (101) to abut against the conductor (200).

2. The socket connector according to claim 1, wherein the slider (400) comprises a push button (430), and the push button (430) protrudes from the insulative body (100) for pushing the slider (400) to move.

3. The socket connector according to claim 1, wherein the insulative body (100) comprises a socket port (105) at one end thereof, the socket port (105) is communicated to one end of the socket (101).

4. The socket connector according to claim 1, wherein the slider (400) comprises a latch (420), and the latch (420) is snap fastened on an internal surfaced of the slide channel (102) when the ball (300) is in the socket (101).

5. The socket connector according to claim 4, wherein the insulative body (100) comprises a window (104) on a lateral surface thereof, the window (104) is communicated with the slide channel (102), and the latch (420) is disposed in the window (104) when the slider (400) is moved away from the locking position and the ball (300) is retreated from the socket (101).

6. The socket connector according to claim 4, wherein the slider (400) comprises an elastic arm (410) and a push button (430), the latch (420) and the push button (430) are disposed together on the elastic arm (410) and linked with the elastic arm (410).

7. The socket connector according to claim 6, wherein the insulative body (100) comprises a window (104) on one lateral surface thereof, the window (104) is communicated with the slide channel (102), the push button (430) protrudes from the insulative body (100) through the window (104) for pressing the elastic arm (410).

8. The socket connector according to claim 1, wherein an elastic part (500) is arranged in the slide channel (102), the elastic part (500) is disposed along a longitudinal direction of the slide channel (102), and the elastic part (500) respectively abuts on an internal surface of the slide channel (102) and the slider (400) so as to push the slider (400) away from the locking position.

9. The socket connector according to claim 1, wherein the conductor (200) comprises a pair of claws (210,220), the pair of claws (210,220) are disposed opposite to each other, one of pair of claws (220) is disposed corresponding to the communicating path (103).
